(19) United States
(12) Patent Application Publication
(10) Pub. No.: US 2021/0209105 A1
(43) Pub. Date: Jul. 8, 2021

(54) QUERY ADAPTATION FOR A SEARCH SERVICE IN A CONTENT MANAGEMENT SYSTEM

(71) Applicant: International Business Machines Corporation, Armonk, NY (US)

(72) Inventors: Timo Kussmaul, Boeblingen (DE); Uwe Hansmann, Tuebingen (DE)

(21) Appl. No.: 16/733,370

(22) Filed: Jan. 3, 2020

(51) Int. Cl. G06F 16/2453; G06F 16/248; G06N 20/00

(52) U.S. Cl. CPC G06F 16/24537; G06N 20/00; G06F 16/248

(57) ABSTRACT

A computer system searches content in a content management system by adapting queries. A search query and contextual information relating to the search query are received, wherein the contextual information includes one or more from a group of: a user identifier, and a view of a client application. A rule query is executed to identify one or more search rules, wherein the rule query is generated based on one or more from a group of: the search query, and the contextual information. The search query is modified by applying the one or more search rules to the search query. The modified search query is executed to select content items. Embodiments of the present invention further include a method and program product for adapting queries in a content management system in substantially the same manner described above.

### BACKGROUND

### 1. Technical Field

Present invention embodiments relate to search services for content management systems, and more specifically, to adapting queries for a search service in a content management system to improve the quality of search results.

### 2. Discussion of the Related Art

In a content management system, users may collaborate to manage and create digital content items, such as text documents, web pages, images, videos, code scripts, and the like. Content management systems are often based on separate content authoring and content delivery systems, with content authoring including the creation and modification of content, and content delivery referring to the process of providing content to users. A content management system may include a search service that enables content authors to search for content items and enables end users to find content when browsing a website or search-based application. Therefore, the quality of a search service is an important aspect of the user experience of end users and administrators alike.

### SUMMARY

According to one embodiment of the present invention, a computer system searches content in a content management system by adapting queries. A search query and contextual information relating to the search query are received, wherein the contextual information includes one or more from a group of: a user identifier, and a view of a client application. A rule query is executed to identify one or more search rules, wherein the rule query is generated based on one or more from a group of: the search query, and the contextual information. The search query is modified by applying the one or more search rules to the search query. The modified search query is executed to select content items. Embodiments of the present invention further include a method and program product for adapting queries in a content management system in substantially the same manner described above.

### BRIEF DESCRIPTION OF THE DRAWINGS

Generally, like reference numerals in the various figures are utilized to designate like components.

FIG. 1 is a block diagram depicting a computing environment for search query adaptation in accordance with an embodiment of the present invention;

FIG. 2 is a flow chart depicting a method of query adaptation and execution in accordance with an embodiment of the present invention;

FIG. 3 is a flow chart depicting a method of generating search rules for query adaptation in accordance with an embodiment of the present invention;

FIGS. 4A-4F are block diagrams depicting user interfaces for generating search rules in accordance with an embodiment of the present invention; and

FIG. 5 is a block diagram depicting a computing device in accordance with an embodiment of the present invention.

### DETAILED DESCRIPTION

Present invention embodiments relate to search services for content management systems, and more specifically, to adapting queries for a search service in a content management system to improve the quality of search results. A content management system may include any form of content, such as text, media, web pages, and the like. Content may be created and edited using an authoring component of the content management system, and content may be published to end users by a content delivery component. In order to provide these capabilities, content management systems are often implemented as a set of interacting services that are made accessible to external applications via an application programming interface (API) gateway. One of the services included in content management systems is a search service, which processes received queries to identify relevant content for users.

Present invention embodiments automatically adapt received search queries in order to improve relevancy of search results (e.g., content) presented to a user. A query may be adapted by selecting a rule to apply to the query, which results in a modification to the query. For example, a boosting keyword can be added to a query, causing the search service to return results that might otherwise not have been selected or ranked as highly (e.g., based on the user's original query). Query adaptation involves a two-phase process: first, a received search query is processed to select one or more rules to be applied to the query; applying the one or more rules to the query produces a modified query, which is then processed by a search service to identify content. A search rule is selected in the first phase based on one or more factors, including keywords in the search query and other contextual information. Contextual information may include the identity of the user providing the search query, and the user's view in an application when the search query is made.

Thus, search rules can be applied in a manner that adapts a user's query based not only on the keywords of the query, but also on the context in which the query was made. For example, different rules can be applied to a same search query arising from two different users, or different rules can be applied to a same search query when the query is made while a user is currently viewing different content, etc. Accordingly, present invention embodiments improve search query processing by adapting search queries in a manner that captures the context of the query in addition to query keywords, enabling a high degree of precision in selecting the rules that are applied to the query. By adapting search queries according to the embodiments presented herein, a search service can be optimized, resulting in an improved user experience (e.g., a user can find relevant content more quickly) as well as a reduction in the amount of computational resources that are consumed (e.g., by avoiding the processing of search queries that would return irrelevant content).

It should be noted that references throughout this specification to features, advantages, or similar language herein do not imply that all of the features and advantages that may be realized with the embodiments disclosed herein should be, or are in, any single embodiment of the invention. Rather, language referring to the features and advantages is understood to mean that a specific feature, advantage, or characteristic described in connection with an embodiment is included in at least one embodiment of the present invention. Thus, discussion of the features, advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages will become more fully apparent from the following drawings, description and appended claims, or may be learned by the practice of embodiments of the invention as set forth hereinafter.

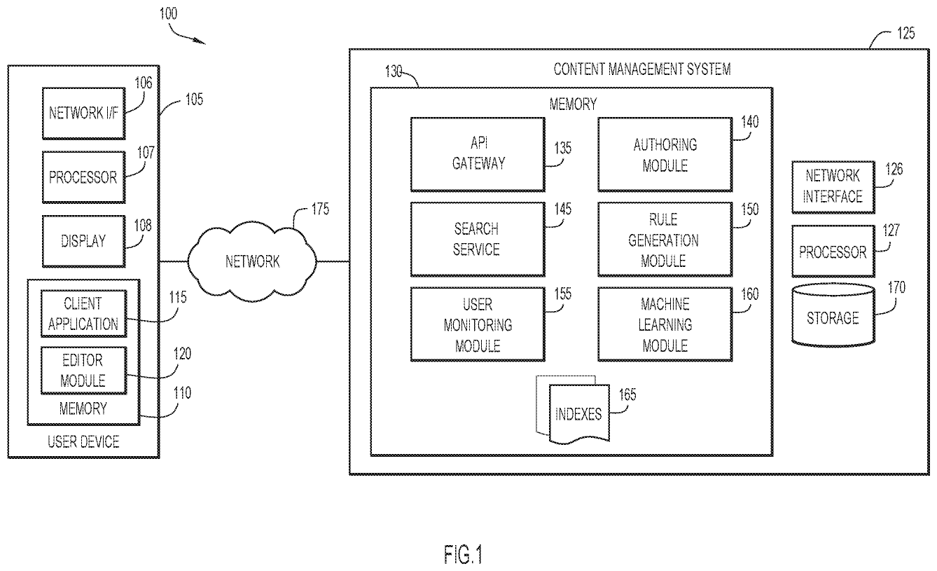

Present invention embodiments will now be described in detail with reference to the Figures. FIG. 1 is a block diagram depicting a computing environment 100 for search query adaptation in accordance with an embodiment of the present invention. As depicted, computing environment 100 includes user device 105, a content management system 125, and a network 175. It is to be understood that the functional division among components of computing environment 100 have been chosen for purposes of explaining present invention embodiments and is not to be construed as a limiting example.

User device 105 includes a network interface (I/F) 106, at least one processor 107, a display 108, and memory 110. Memory 110 may include a client application 115 and an editor module 120. User device 105 may include a laptop computer, a tablet computer, a netbook computer, a personal computer (PC), a desktop computer, a personal digital assistant (PDA), a smart phone, a thin client, or any programmable electronic device capable of executing computer readable program instructions. Network interface 106 enables components of user device 105 to send and receive data over a network, such as network 175. In some embodiments, a user of user device 105 can access content management system 125 in order to create, edit, and view content. Additionally or alternatively, a user of user device 105 can access content management system 125 to create and modify search rules for query adaptation. User device 105 may include internal and external hardware components, as depicted and described in further detail with respect to FIG. 5.

Display 108 may include any electronic device capable of presenting information in a visual form. For example, display 108 may be a liquid crystal display (LCD), a cathode ray tube (CRT) display, a light-emitting diode (LED) display, an electronic ink display, and the like. Information relating to a content management system may be displayed to a user of user device 105 via display 108, including queries, retrieved content, search rules for adapting queries, views of search-based applications, and the like.

Client application 115 and editor module 120 may include one or more modules or units to perform various functions of present invention embodiments described below. Client application 115 and editor module 120 may be implemented by any combination of any quantity of software and/or hardware modules or units, and may reside within memory 110 of user device 105 for execution by a processor, such as processor 107.

Client application 115 may include any application for creating, editing, browsing, and/or accessing content associated with content management system 125, which can include any text, media, web pages, and the like. Client application 115 may include a web browser or other software client for accessing and displaying content.

In some embodiments, client application 115 is a search-based application that utilizes a search service for information access and reporting. During runtime, a search-based application may utilize a search service of a content management system to identify and retrieve content, navigation information, site and page structure, header and footer information, and the like, to support functionality of the application. Client application 115 may send a series of search queries to a search service to retrieve information that is required for rendering the application's current view. Thus, a search-based application may not require a dedicated database, file system, or other persistent components in order to manage information. Client application 115 may present a user interface, via display 108, that includes components for rendering information, such as page headers and footers, navigation structures (e.g., pages of returned search results, scroll bars, etc.), for rendering a page. Thus, the layout of a view of client application 115 can be separated from the content and the navigation structure.

Content authors may use content management system 125 to create and/or edit content that is relevant for a search-based application, such as site and page structure, navigation structure, as well as media such as images, videos, and the like. Content authors may create new pages, author new content, and define new content types and page types. A modified site can be reviewed, approved, and published through content management system 125, which may index the data so that client application 115 may access the data via a search service, such as search service 145.

Editor module 120 may include a user interface for creating and editing content items in order to generate rules for the adaptation of search queries. In particular, a user may interact with sample content items using editor module 120 to create and/or modify views of client application 115. In some embodiments, editor module 120 includes a drag-and-drop interface that enables a user to add content from content management system 125 to a view of client application 115, to remove content, to reorder or otherwise rearrange content, and the like. For example, a user may edit a view of client application 115, that is generated based on a search query, to present content in a different order; this modified view may then be processed according to present invention embodiments to generate a search rule for adapting queries.

Content management system 125 may include a network interface 126, at least one processor 127, memory 130, and storage 170. Memory 130 may include an API gateway 135, an authoring module 140, a search service 145, a rule generation module 150, a user monitoring module 155, a machine learning module 160, and one or more indexes 165. In various embodiments of the present invention, content management system 125 may include a laptop computer, a tablet computer, a netbook computer, a personal computer (PC), a desktop computer, a personal digital assistant (PDA), a smart phone, or any programmable electronic device capable of executing computer readable program instructions. Network interface 126 enables components of content management system 125 to send and receive data over a network, such as network 175. In general, content management system 125 and its modules may serve content to client applications, such as client application 115, by processing and adapting search queries in accordance with presented embodiments. Additionally, content management system 125 and its modules may provide for the manual and/or automatic generation of search rules for adapting search queries. Content management system 125 may include internal and external hardware components, as depicted and described in further detail with respect to FIG. 5.

API gateway 135, authoring module 140, search service 145, rule generation module 150, user monitoring module 155, and machine learning module 160 may include one or more modules or units to perform various functions of present invention embodiments described below. API gateway 135, authoring module 140, search service 145, rule generation module 150, user monitoring module 155, and machine learning module 160 may be implemented by any combination of any quantity of software and/or hardware modules or units, and may reside within memory 130 of content management system 125 for execution by a processor, such as processor 127.

API gateway 135 may enable a client application, such as a desktop application, a mobile device application, scripts executed in a web browser, and the like, to access content management system 125. For example, client application 115 of user device 105 may access content management system 125 and its services via API gateway 135. When a request is received from a client application, API gateway 135 accesses a service registry to obtain the network address or other identifier for a service instance to which the request may be forwarded. Thus, when client application 115 transmits a search query to content management system 125, API gateway 135 may forward the request to search service 145. In some embodiments, the service registry includes an updated list of the instances of services and the health status of each instance, enabling API gateway 135 to forward a request to a healthy instance of a search service 145.

Authoring module 140 enables content authors to create, edit, and retrieve content items, and may include a user interface and/or authoring APIs. Authoring module 140 may import content to content management system 125. Content authors may access authoring module 140 via client application 115 in order to create new pages, author new content, and define new content types and page types. In some embodiments, authoring module 140 indicates any content changes, including the addition, removal, and/or modification of content, to search service 145 so that the changed content can be indexed accordingly.

Search service 145 may process search queries against a search index to retrieve relevant content. A search query may initially be provided by a user of user device 105, and may include one or more search terms or keywords. In addition, a search query may include Boolean operators. Search service 145 employs a two-step approach in which a received search query is first processed to select one or more search rules to be applied to the query. Rules that are selected in the first step are then applied to the search query to produce a modified query, which is then processed by search service 145 to identify relevant content.

Search rules may be manually defined by users or may be generated automatically. Each search rule may include a precondition and an action to rewrite a search query, which can be represented using an IF/THEN semantic. The precondition refers to one or more search terms that are included in a query, and the action contains instructions to modify a query if the precondition is satisfied. For example, a search query may have a precondition and action such that, when a search query includes the terms “laptop,” “desktop,” “tablet,” a brand, “XYZ,” is added to the query. Thus, when search service 145 receives a search query that includes the term “laptop,” the search query may be rewritten as “XYZ laptop,” which search service 145 then processes to return results that include content associated with laptops of brand XYZ. Thus, a search rule adapts a search query by modifying the query in some manner to alter the results that are returned, including the content that is returned and/or the order in which the content is presented.

In addition to using search terms as preconditions, search service 145 may implement search rules with preconditions that are satisfied according to contextual information that is associated with a search query. Contextual information can include an identifier of a user associated with the user device sending the search query, or an identifier of the device itself. Thus, search rules may be selectively applied to the search queries of specific users, devices, groups of users, and/or groups of devices. Additionally or alternatively, contextual information may include a view of an application's user interface, such as client application 115. For example, if a user provides a search query when the user is viewing a particular subsection of a website, such as an “electronics” section, one search rule may be applied to the query, whereas if the user provides a search query when the user is viewing an “apparel” section of the website, another search rule may be applied.

Search service 145 processes a search query using a search index, such as any of indexes 165. In general, a search index includes a representation of content that enables search service 145 to quickly identify content that is relevant to a search query. Content that is indexed by search service 145 may be stored locally in content management system 125. Additionally or alternatively, content that is indexed by search service 145 may be stored in one or more other computing systems accessible via network 175. Search service 145 may identify content that is relevant to a search query by scoring and ranking content items relative to the search query terms. Search service 145 may employ conventional or other ranking techniques, such as term frequency-inverse document frequency (tf-idf) approaches, in order to rank content.

In some embodiments, search rules are stored in a same index that indexes content. Search rules may be stored in a search index as dedicated content items of a special type. Thus, search service 145 may use a same search index to perform both phases of a search. In particular, when a search query is received, search service 145 performs a first search that returns search rules (e.g., content items of the special type), which are ranked according to the keywords of the search query and/or contextual information. Once one or more rules are applied to modify the search query, search service 145 performs a second search, using the same search index, that omits search rules and instead ranks content items like documents, web pages, media, etc.

Rule generation module 150 automatically creates search rules based on feedback from editor module 120. A user may modify a view of client application 115 using editor module 120 to add, remove, and/or reorder content. Rule generation module 150 may compare the resulting modified view to the original view, and based on the comparison, generate a search rule. In particular, rule generation module 150 may identify a search query that results in an original view, and then rule generation module 150 may determine one or more modifications to the search query that would result in the modified view. For example, if a user modifies a view produced by a search query to include additional content, rule generation module 150 may produce a search rule that adds one or more keywords to the search query that would ensure that the added content is included in the results returned by a modified search query.

Rule generation module 150 may generate a search rule that has a precondition that would be satisfied by the keywords and/or contextual information of the search query used to create the original view, and may select an action for the search rule by selecting one or more keywords based on the content that is added, removed or edited in producing the modified view. Machine learning module 160 may identify keywords for a search rule by employing a natural language processing function to extract the most relevant keywords from a text of the content. In particular, machine learning module 160 may utilize conventional or other natural language processing techniques to extract keywords. In some embodiments, machine learning module 160 trains a natural language processing model using domain-specific training data for one or more domains that are relevant to the content of content management system 125.

In some embodiments, machine learning module 160 employs a machine learning model to perform scoring and/or classification of keywords using custom training data. Machine learning module 160 may obtain a score for each keyword that indicates how useful the keyword is for a user or set of users in one particular view of client application 115. Machine learning module 160 may employ a scoring function that processes keywords of a search query as well as details of an application view and/or a user identifier to score keywords in an application view-specific and/or user-specific manner.

The scoring function may be machine-learned from training data that is obtained by user monitoring module 155. User monitoring module 155 may obtain information relating to users' behavior and usage of client applications, such as client application 115 of user device 105. User monitoring module 155 may monitor users by receiving data from client application 115 and/or by tracking user search queries, content requests, etc., that are received by content management system 125. In some embodiments, client application 115 is a search-based application that implements a monitoring extension for gathering data for user monitoring module 155, which then creates training data for the scoring function. The training data may include application views, user identifiers, extracted keywords, and feedback metrics, such as whether previous user interactions with added content were positive or negative given the keywords that were selected for the content. Thus, using the feedback obtained by user monitoring module 155, the scoring function may be trained to score keywords based on user interactions with previously added content.

Indexes 165 may include one or more search indexes for search service 145. Each index 165 indexes content managed by content management system 125. In addition, indexes 165 may index search rules that can be applied to search queries. In some embodiments, content management system 125 provides management services for multiple tenants, organizations, or other groups of users, and maintains a separate index 165 for each entity. Thus, different content may be returned to users associated with different tenants, and search rules may be created and applied on a tenant-by-tenant basis.

Storage 170 may include any non-volatile storage media known in the art. For example, storage 170 can be implemented with a tape library, optical library, one or more independent hard disk drives, or multiple hard disk drives in a redundant array of independent disks (RAID). Similarly, data in storage 170 may conform to any suitable storage architecture known in the art, such as a file, a relational database, an object-oriented database, and/or one or more tables. In some embodiments, storage 170 may store data relating to search query processing and adaptation, including content, user feedback, training data sets, and the like.

Network 175 may include a local area network (LAN), a wide area network (WAN) such as the Internet, or a combination of the two, and includes wired, wireless, or fiber optic connections. In general, network 175 can be any combination of connections and protocols known in the art that will support communications between user device 105 and content management system 125 via their respective network interfaces in accordance with embodiments of the present invention.

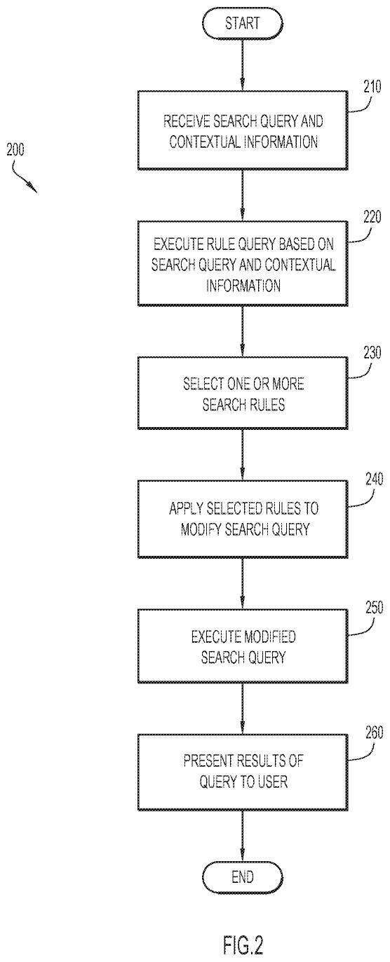

FIG. 2 is a flow chart depicting a method 200 of query adaptation and execution in accordance with an embodiment of the present invention.

A search query and contextual information relating to the query are received at operation 210. A search query may be received by search service 145 of content management system 125 from client application 115 of user device 105. The search query includes one or more keywords or terms, and may additionally include Boolean operators or other conditional logic. The contextual information may include the context of client application 115 when the search query was provided, including a view of the user interface of client application 115. A view may be defined according to an identifier, such as a uniform resource locator (URL) of a web page rendered in client application 115, a listing of content items presented in the view, a hash value generated based on the view, or any other description of the view. Contextual information may also include an identifier for the user associated with client application 115 and/or an identifier for user device 105.

A rule query is executed based on the search query and the contextual information at operation 220. Search service 145 may perform a rule query against a search index (e.g., any of indexes 165) in order to select search rules. In some embodiments, search rules are stored as content items of a special type in a same index that indexes content items, and search service 145 executes the rule query only against items labeled as search rule type. The rule query may include one or more keywords obtained from the search query, and may also contain the contextual information received with the search query. During execution of the rule query, search service 145 may identify one or more search rules whose preconditions are satisfied by any of the keywords and/or the contextual information.

The selected rules are applied to modify the original search query at operation 240. A rule's action may be applied to the search query in order to generate a modified query by, e.g., adding subqueries, removing keywords, replacing keywords with other keywords, or performing other operations, such as adding or removing Boolean operators. In some embodiments, when multiple search rules are returned by the rule query, some or all of the search rules are applied to the search query.

The modified search query is executed at operation 250. Search service 145 may process the modified search query against an index in order to identify content items that are relevant to the keywords of the modified search query. Search service 145 identifies content that is relevant to the modified search query by scoring and ranking content according to conventional or other ranking techniques, such as a term frequency-inverse document frequency (tf-idf) ranking, in order to rank content.

The results of executing the modified search query are presented to a user at operation 260. Search results may be presented to a user of user device 105 in a user interface of client application 115. Content may be presented to a user in an order of relevancy as determined according to search service 145, or may be sorted according to user-specified features or details of the content.

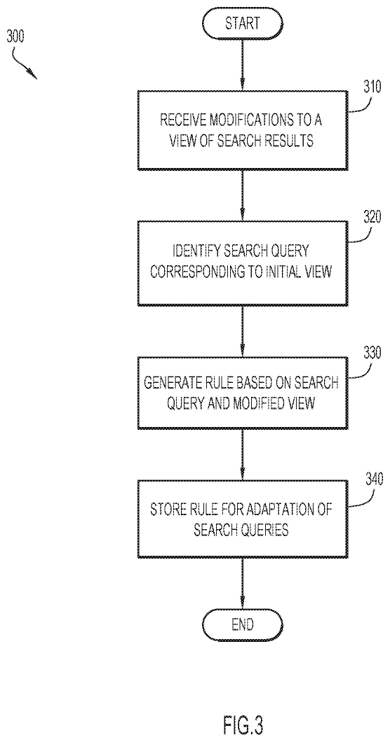

FIG. 3 is a flow chart depicting a method 300 of generating search rules for query adaptation in accordance with an embodiment of the present invention.

One or more modifications to a view of search results are received at operation 310. An initial view may be presented to a user of user device 105 that contains content selected as a result of processing a search query. The view may be presented by client application 115, and may be rendered alongside a drag-and-drop interface provided by editor module 120. A user may modify the view by interacting with editor module 120 to add, remove, and/or modify the content that is included in the view. For example, a user may drag-and-drop content to reorder the content, or may drag-and-drop content items from a list of other content items to add the content to the view. The modifications to the view may be received by rule generation module 150 of content management system 125.

The search query that resulted in the initial view of the search results is identified at operation 320. Rule generation module 150 may identify the search query and the contextual information that was processed to generate the initial (e.g., unmodified) view.

A search rule is generated based on the search query and the modified view at operation 330. Rule generation module 150 may determine actions that can be applied to the search query so that processing of the search query by search service 145 will return content associated with the modified view rather than the initial view. For example, if a user modifies a view by reordering content, rule generation module 150 may generate a search rule that adds one or more keywords to the search query such that processing the modified query returns content in the modified order.

Rule generation module 150 may select a precondition for the generated search rule that is satisfied by one or more of: keywords of the search query, and the contextual information relating to the search query. The action of the generated search rule may include adding one or more keywords to the search query, which may be selected by processing the content of the modified view via machine learning module 160. Additionally or alternatively, the keywords may be selected using a machine learning model that is trained based on the previous user interactions gathered by user monitoring module 155.

The search rule is stored for adapting search queries at operation 340. The search rule may be stored as a content item of a special type that is indexed in one or more indexes 165.

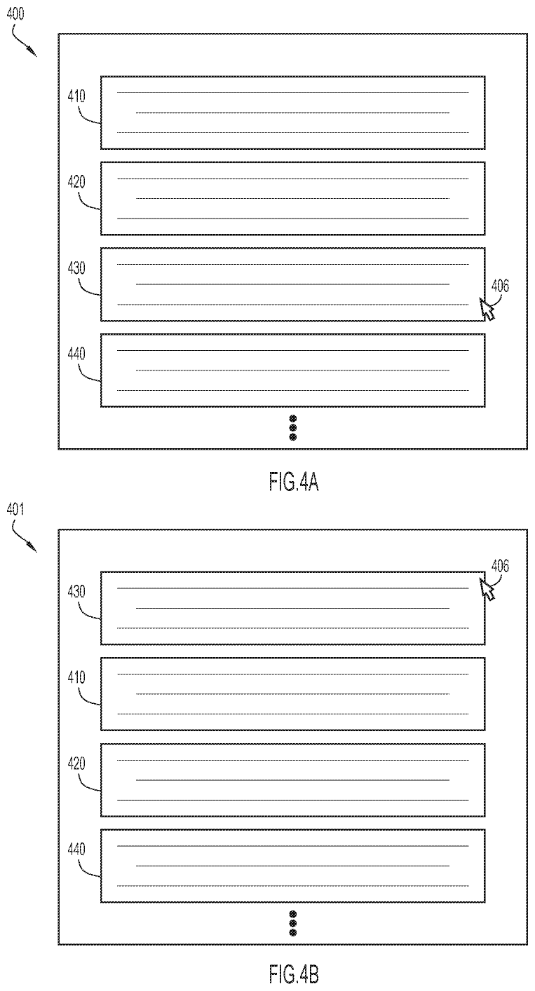

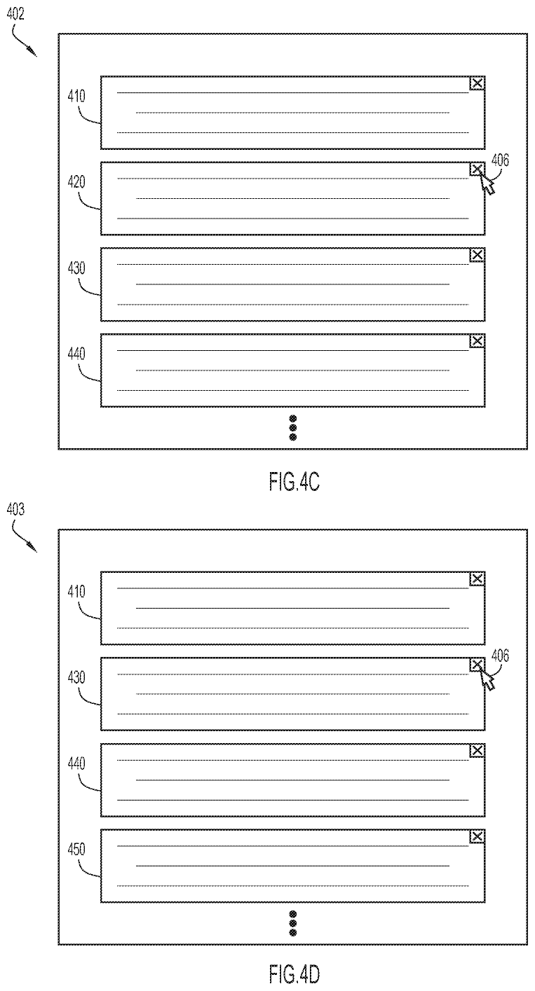

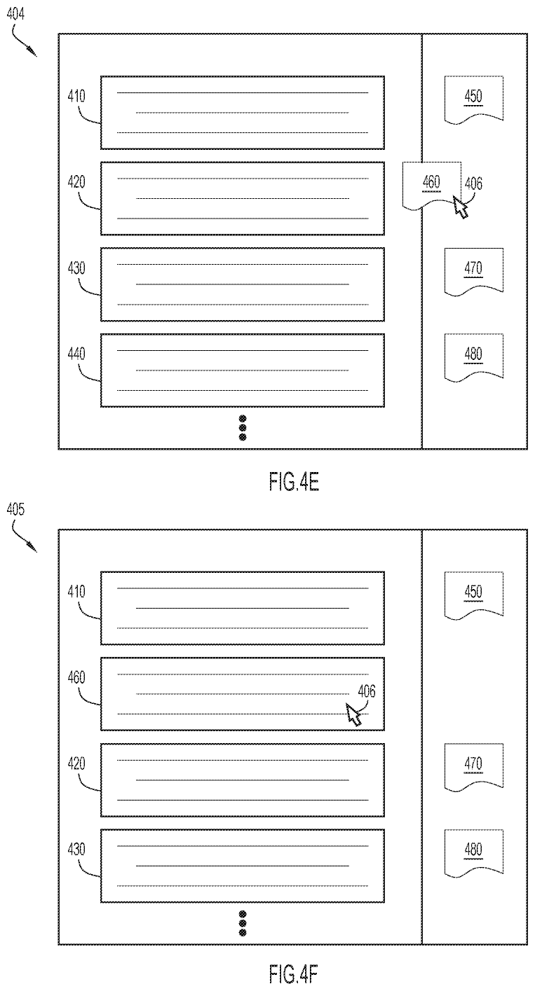

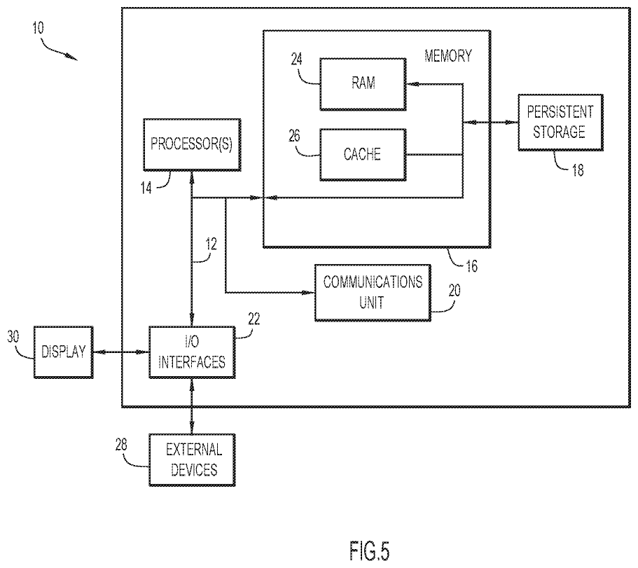

FIGS. 4A-4F are block diagrams depicting user interfaces 400-405 for generating search rules in accordance with an embodiment of the present invention.

User interface 400 (FIG. 4A) depicts a view of client application 115 that can be modified by editor module 120. Content items 410, 420, 430, and 440 are presented to a user in a descending order, and the user may provide input using cursor 406 to modify the view. User interface 401 (FIG. 4B) depicts a modified view in which a user has reordered the content items. In this depicted example, content item 430 has been moved to the top of the view, and accordingly content items 410, 420, and 440 are listed in descending order below. Based on this modified view, rule generation module 150 may generate a search rule to modify the search query associated with the view depicted in user interface 400 such that content is instead presented to the user according to the ordering depicted in user interface 401.

User interface 402 (FIG. 4C) depicts a view that is being modified by a user to remove a content item. As a result, user interface 403 (FIG. 4D) depicts a modified view in which the user has removed content item 420, increasing the ranking of content items 430 and 440 and enabling a new content item 450 to be included in the view. Based on this modified view, rule generation module 150 may generate a search rule to modify the search query associated with the view depicted in user interface 402 such that processing the modified search query returns content as depicted in user interface 403.

User interface 404 (FIG. 4E) depicts a view that is being modified by a user to insert a content item. As a result, user interface 405 (FIG. 4F) depicts a modified view in which the user has inserted new content item 460 between content items 410 and 420, causing content item 430 to be moved further down and causing content item 440 to no longer remain in the view. Based on this modified view, rule generation module 150 may generate a search rule to modify the search query associated with the view depicted in user interface 402 such that processing the modified search query returns content as depicted in user interface 403.

FIG. 5 is a block diagram depicting components of a computer 10 suitable for executing the methods disclosed herein. Computer 10 may implement user device 105 and/or content management system 125 in accordance with embodiments of the present invention. It should be appreciated that FIG. 5 provides only an illustration of one embodiment and does not imply any limitations with regard to the environments in which different embodiments may be implemented. Many modifications to the depicted environment may be made.

As depicted, the computer 10 includes communications fabric 12, which provides communications between computer processor(s) 14, memory 16, persistent storage 18, communications unit 20, and input/output (I/O) interface(s) 22. Communications fabric 12 can be implemented with any architecture designed for passing data and/or control information between processors (such as microprocessors, communications and network processors, etc.), system memory, peripheral devices, and any other hardware components within a system. For example, communications fabric 12 can be implemented with one or more buses.

Memory 16 and persistent storage 18 are computer readable storage media. In the depicted embodiment, memory 16 includes random access memory (RAM) 24 and cache memory 26. In general, memory 16 can include any suitable volatile or non-volatile computer readable storage media.

One or more programs may be stored in persistent storage 18 for execution by one or more of the respective computer processors 14 via one or more memories of memory 16. The persistent storage 18 may be a magnetic hard disk drive, a solid state hard drive, a semiconductor storage device, read-only memory (ROM), erasable programmable read-only memory (EPROM), flash memory, or any other computer readable storage media that is capable of storing program instructions or digital information.

The media used by persistent storage 18 may also be removable. For example, a removable hard drive may be used for persistent storage 18. Other examples include optical and magnetic disks, thumb drives, and smart cards that are inserted into a drive for transfer onto another computer readable storage medium that is also part of persistent storage 18.

Communications unit 20, in these examples, provides for communications with other data processing systems or devices. In these examples, communications unit 20 includes one or more network interface cards. Communications unit 20 may provide communications through the use of either or both physical and wireless communications links.

I/O interface(s) 22 allows for input and output of data with other devices that may be connected to computer 10. For example, I/O interface 22 may provide a connection to external devices 28 such as a keyboard, keypad, a touch screen, and/or some other suitable input device. External devices 28 can also include portable computer readable storage media such as, for example, thumb drives, portable optical or magnetic disks, and memory cards.

Software and data used to practice embodiments of the present invention can be stored on such portable computer readable storage media and can be loaded onto persistent storage 18 via I/O interface(s) 22. I/O interface(s) 22 may also connect to a display 30. Display 30 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Data relating to adapting queries for a search service in a content management system (e.g., search query data, data relating to content, search rules data, index data, user feedback data, machine learning model training data, etc.) may be stored within any conventional or other data structures (e.g., files, arrays, lists, stacks, queues, records, etc.) and may be stored in any desired storage unit (e.g., database, data or other repositories, queue, etc.). The data transmitted between user device 105 and/or content management system 125 may include any desired format and arrangement, and may include any quantity of any types of fields of any size to store the data. The definition and data model for any datasets may indicate the overall structure in any desired fashion (e.g., computer-related languages, graphical representation, listing, etc.).

Data relating to adapting queries for a search service in a content management system (e.g., search query data, data relating to content, search rules data, index data, user feedback data, machine learning model training data, etc.) may include any information provided to, or generated by, user device 105 and/or content management system 125. Data relating to adapting queries for a search service in a content management system may include any desired format and arrangement, and may include any quantity of any types of fields of any size to store any desired data. The data relating to adapting queries for a search service in a content management system may include any data collected about entities by any collection mechanism, any combination of collected information, and any information derived from analyzing collected information.

The present invention embodiments may employ any number of any type of user interface (e.g., Graphical User Interface (GUI), command-line, prompt, etc.) for obtaining or providing information (e.g., data relating to adapting queries for a search service in a content management system), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

It will be appreciated that the embodiments described above and illustrated in the drawings represent only a few of the many ways of adapting queries for a search service in a content management system.

The environment of the present invention embodiments may include any number of computer or other processing systems (e.g., client or end-user systems, server systems, etc.) and databases or other repositories arranged in any desired fashion, where the present invention embodiments may be applied to any desired type of computing environment (e.g., cloud computing, client-server, network computing, mainframe, stand-alone systems, etc.). The computer or other processing systems employed by the present invention embodiments may be implemented by any number of any personal or other type of computer or processing system (e.g., desktop, laptop, PDA, mobile devices, etc.), and may include any commercially available operating system and any combination of commercially available and custom software (e.g., browser software, communications software, server software, client application 115, editor module 120, API gateway 135, authoring module 140, search service 145, rule generation module 150, user monitoring module 155, machine learning module 160, etc.). These systems may include any types of monitors and input devices (e.g., keyboard, mouse, voice recognition, etc.) to enter and/or view information.

It is to be understood that the software (e.g., browser software, communications software, server software, client application 115, editor module 120, API gateway 135, authoring module 140, search service 145, rule generation module 150, user monitoring module 155, machine learning module 160, etc.) of the present invention embodiments may be implemented in any desired computer language and could be developed by one of ordinary skill in the computer arts based on the functional descriptions contained in the specification and flowcharts illustrated in the drawings. Further, any references herein of software performing various functions generally refer to computer systems or processors performing those functions under software control. The computer systems of the present invention embodiments may alternatively be implemented by any type of hardware and/or other processing circuitry.

The various functions of the computer or other processing systems may be distributed in any manner among any number of software and/or hardware modules or units, processing or computer systems and/or circuitry, where the computer or processing systems may be disposed locally or remotely of each other and communicate via any suitable communications medium (e.g., LAN, WAN, Intranet, Internet, hardwire, modem connection, wireless, etc.). For example, the functions of the present invention embodiments may be distributed in any manner among the various end-user/client and server systems, and/or any other intermediary processing devices. The software and/or algorithms described above and illustrated in the flowcharts may be modified in any manner that accomplishes the functions described herein. In addition, the functions in the flowcharts or description may be performed in any order that accomplishes a desired operation.

The software of the present invention embodiments (e.g., browser software, communications software, server software, client application 115, editor module 120, API gateway 135, authoring module 140, search service 145, rule generation module 150, user monitoring module 155, machine learning module 160, etc.) may be available on a non-transitory computer useable medium (e.g., magnetic or optical mediums, magneto-optic mediums, floppy diskettes, CD-ROM, DVD, memory devices, etc.) of a stationary or portable program product apparatus or device for use with stand-alone systems or systems connected by a network or other communications medium.

The communication network may be implemented by any number of any type of communications network (e.g., LAN, WAN, Internet, Intranet, VPN, etc.). The computer or other processing systems of the present invention embodiments may include any conventional or other communications devices to communicate over the network via any conventional or other protocols. The computer or other processing systems may utilize any type of connection (e.g., wired, wireless, etc.) for access to the network. Local communication media may be implemented by any suitable communication media (e.g., local area network (LAN), hardwire, wireless link, Intranet, etc.).

The system may employ any number of any conventional or other databases, data stores or storage structures (e.g., files, databases, data structures, data or other repositories, etc.) to store information (e.g., data relating to adapting queries for a search service in a content management system). The database system may be implemented by any number of any conventional or other databases, data stores or storage structures (e.g., files, databases, data structures, data or other repositories, etc.) to store information (e.g., data relating to adapting queries for a search service in a content management system). The database system may be included within or coupled to the server and/or client systems. The database systems and/or storage structures may be remote from or local to the computer or other processing systems, and may store any desired data (e.g., data relating to adapting queries for a search service in a content management system).

The present invention embodiments may employ any number of any type of user interface (e.g., Graphical User Interface (GUI), command-line, prompt, etc.) for obtaining or providing information (e.g., data relating to adapting queries for a search service in a content management system), where the interface may include any information arranged in any fashion. The interface may include any number of any types of input or actuation mechanisms (e.g., buttons, icons, fields, boxes, links, etc.) disposed at any locations to enter/display information and initiate desired actions via any suitable input devices (e.g., mouse, keyboard, etc.). The interface screens may include any suitable actuators (e.g., links, tabs, etc.) to navigate between the screens in any fashion.

The present invention embodiments are not limited to the specific tasks or algorithms described above, but may be utilized for any number of applications in the relevant fields, including, but not limited to, adapting search queries for any information that may be sought by a user and/or computing system.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising”, “includes”, “including”, “has”, “have”, “having”, “with” and the like, when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

1. A computer-implemented method for searching content in a content management system by adapting queries, comprising:
receiving a search query and contextual information relating to the search query, wherein the contextual information includes one or more from a group of: a user identifier, and a view of a client application;
executing a rule query to identify one or more search rules, wherein the rule query is generated based on one or more from a group of: the search query, and the contextual information;
modifying the search query by applying the one or more search rules to the search query; and
executing the modified search query to select content items.

2. The computer-implemented method of claim 1, wherein a search rule of the one or more search rules is generated by:
receiving one or more modifications to a view of search results presented to a user, wherein the user interacts with the view to modify one or more from a group of: content included in the view, and an order of the content;
identifying an initial search query corresponding to the view of search results prior to the one or more modifications; and
processing the initial search query and the one or more modifications to generate a search rule comprising an action that, when applied to the initial search query, produces the modified search query, wherein processing the modified search query returns the view of search results with the one or more modifications.

3. The computer-implemented method of claim 2, wherein the generated search rule is applied to a subsequent search query when a precondition is satisfied, wherein the precondition is selected based on one or more from a group of: the search query, and the contextual information.

4. The computer-implemented method of claim 3, wherein the precondition is satisfied when a keyword is included in the subsequent search query, wherein the keyword is selected by a machine learning model trained using a training set of data generated from user interactions with results of prior modified search queries.

5. The computer-implemented method of claim 1, wherein the content items and the one or more search rules are indexed in a same index.

6. The computer-implemented method of claim 1, wherein the rule query and the search query are executed by a search service using an index selected from a plurality of indexes each associated with a different tenant.

7. The computer-implemented method of claim 1, wherein the client application is a search-based application.

8. A computer system for searching content in a content management system by adapting queries, the computer system comprising:
one or more computer processors;
one or more computer readable storage media;
program instructions stored on the one or more computer readable storage media for execution by at least one of the one or more computer processors, the program instructions comprising instructions to:
receive a search query and contextual information relating to the search query, wherein the contextual information includes one or more from a group of: a user identifier, and a view of a client application;
execute a rule query to identify one or more search rules, wherein the rule query is generated based on one or more from a group of: the search query, and the contextual information;
modify the search query by applying the one or more search rules to the search query; and
execute the modified search query to select content items.

9. The computer system of claim 8, wherein a search rule of the one or more search rules is generated by:
receiving one or more modifications to a view of search results presented to a user, wherein the user interacts with the view to modify one or more from a group of: content included in the view, and an order of the content;
identifying an initial search query corresponding to the view of search results prior to the one or more modifications; and
processing the initial search query and the one or more modifications to generate a search rule comprising an action that, when applied to the initial search query, produces the modified search query, wherein processing the modified search query returns the view of search results with the one or more modifications.

10. The computer system of claim 9, wherein the generated search rule is applied to a subsequent search query when a precondition is satisfied, wherein the precondition is selected based on one or more from a group of: the search query, and the contextual information.

11. The computer system of claim 10, wherein the precondition is satisfied when a keyword is included in the subsequent search query, wherein the keyword is selected by a machine learning model trained using a training set of data generated from user interactions with results of prior modified search queries.

12. The computer system of claim 8, wherein the content items and the one or more search rules are indexed in a same index.

13. The computer system of claim 8, wherein the rule query and the search query are executed by a search service using an index selected from a plurality of indexes each associated with a different tenant.

14. The computer system of claim 8, wherein the client application is a search-based application.

15. A computer program product for searching content in a content management system by adapting queries, the computer program product comprising a computer readable storage medium having program instructions embodied therewith, the program instructions executable by a computer to cause the computer to:
receive a search query and contextual information relating to the search query, wherein the contextual information includes one or more from a group of: a user identifier, and a view of a client application;
execute a rule query to identify one or more search rules, wherein the rule query is generated based on one or more from a group of: the search query, and the contextual information;
modify the search query by applying the one or more search rules to the search query; and
execute the modified search query to select content items.

16. The computer program product of claim 15, wherein a search rule of the one or more search rules is generated by:
receiving one or more modifications to a view of search results presented to a user, wherein the user interacts with the view to modify one or more from a group of: content included in the view, and an order of the content;
identifying an initial search query corresponding to the view of search results prior to the one or more modifications; and
processing the initial search query and the one or more modifications to generate a search rule comprising an action that, when applied to the initial search query, produces the modified search query, wherein processing the modified search query returns the view of search results with the one or more modifications.

17. The computer program product of claim 16, wherein the generated search rule is applied to a subsequent search query when a precondition is satisfied, wherein the precondition is selected based on one or more from a group of: the search query, and the contextual information.

18. The computer program product of claim 17, wherein the precondition is satisfied when a keyword is included in the subsequent search query, wherein the keyword is selected by a machine learning model trained using a training set of data generated from user interactions with results of prior modified search queries.

19. The computer program product of claim 15, wherein the content items and the one or more search rules are indexed in a same index.

20. The computer program product of claim 15, wherein the rule query and the search query are executed by a search service using an index selected from a plurality of indexes each associated with a different tenant.
